(19) United States
(12) Patent Application Publication
(10) Pub. No.: US 2003/0110703 A1
(43) Pub. Date: Jun. 19, 2003

(54) Flush egress window assembly

(75) Inventor: Michael D. Kobrehel, Elkhart, IN (US)

Correspondence Address: BANNER & WITCOFF LTD.,, ATTORNEYS FOR DURA AUTOMOTIVE, 28 STATE STREET - 28TH FLOOR, BOSTON, MA, 02109, US

(73) Assignee: Dura Global Technologies, Inc., Rochester Hills, MI

(21) Appl. No.: 10/024,617

(22) Filed: Dec. 18, 2001

(51) Int. Cl. E05C 17/00

(52) U.S. Cl. 49/394

(57) ABSTRACT

A window assembly includes a pane having an interior surface, an exterior surface, a top edge, a bottom edge, and two side edges. A frame has a header, a bottom with a latching portion, and two sides. A window frame is attached to the pane solely by adhesive bonding to the interior surface of the pane, and a hinge member is attached to the pane solely by adhesive bonding to the interior surface of the pane proximate the top edge of the pane. A latch is attached to the pane solely by adhesive bonding to the interior surface of the pane remote from the top edge of the pane and is operable to engage the latching portion of the footer.

### FIELD OF THE INVENTION

The present invention relates to egress window assemblies, and more particularly to egress window assemblies for vehicle windows that are capable of being flush mounted.

### BACKGROUND OF THE INVENTION

Passenger vehicles such as busses, rail cars, and the like are required to have means for escape in case of emergency. These escape means typically are through a window that can be removed or opened, commonly referred to as an egress window. It is desirable to have a window design that permits the window to be opened and permit egress of the passengers in an emergency, but that is also capable of being tightly shut and sealed in normal operation to reduce wind resistance and wind noise, and provide a desirable appearance.

Canadian Patent No. 1,057,796 to Niessner discloses a frameless window sash for an egress window held against a flexible rubber seal. The hinge and latch mechanisms are directly bolted to the window through apertures in the window pane itself. Hinge members are attached to the window pane on the exterior surface of the window pane. This results in a window pane with hinge members and connecting bolts protruding outward from the exterior surface of the window pane, resulting in wind resistance and noise and an unsightly appearance.

Canadian Patent Application No. 2,258,314 to Blackburn discloses a flush-mounted frameless vehicle window, including both fixed and egress windows. The window is bonded to a hinge extrusion that sits on the exterior of the window, preventing a flush exterior finish.

U.S. Pat. No. 5,551,197 to Repp et al. discloses a flush-mounted articulated venting window assembly suitable for heavy windows. The window described has at least one hinge adhesively mounted to the interior surface of a window pane, a latch mechanism adhesively mounted to the opposing end on the interior surface, and a gasket for sealing the window adhesively mounted to either the inner surface of the window or to the window opening of the vehicle. Mounting members do not extend completely around the peripheral edge of the pane.

It is an object of the present invention to provide a flush egress window assembly that reduces or wholly overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of certain preferred embodiments.

### SUMMARY

To enhance exterior styling of vehicles, certain preferred embodiments of the present invention provide an egress window assembly advantageously employing one-sided bonding such that a hinge member and latch mechanism are attached to the window pane, free of the outer surface of the window pane. The outer surface may be positioned generally flush with an exterior surface of an adjacent body panel of the vehicle and/or may be positioned generally flush with an adjacent window pane, and may be positioned such that the peripheral edge of the window assembly pane is substantially abutting a peripheral edge of an adjacent window pane. The window of this invention is capable of being mounted flush to the vehicle outer skin, which provides for both improved aerodynamics and aesthetics.

In accordance with a first aspect, a window assembly includes a pane having an interior surface, an exterior surface, a top edge, a bottom edge, and two side edges. A frame includes a header, a footer with a latching portion, and two sides, with the pane being positioned within the frame. A window frame is attached to the pane solely by adhesive bonding to the interior surface of the pane. A hinge member is attached to the pane solely by adhesive bonding to the interior surface of the pane proximate the top edge of the pane and operably connected to the header. A latch is attached to the pane solely by adhesive bonding to the interior surface of the pane remote from the top edge of the pane and is operable to engage the latching portion of the footer.

In accordance with another aspect, a window assembly includes a pane, a hinge, and a latch assembly. The latch assembly includes a latch bolt housing mounted to the pane, a latch bolt slidingly mounted to the latch bolt housing for movement in a plane substantially parallel to the plane of the pane between a first position and a second position, a biasing member operative to urge the latch bolt toward the first position, and a release handle remote from the latch bolt and operative to move the latch bolt from the first position toward the second position against a biasing force of the biasing member. The latch assembly and the hinge each are attached to the pane solely by adhesive bonding to an interior surface of the pane.

In accordance with yet another aspect, a window assembly includes a pane having an interior surface, an exterior surface, and a peripheral edge. A window frame extends around a full perimeter of the pane inward of the peripheral edge of the pane and is attached to the pane solely by adhesive bonding to the interior surface of the pane. A hinge member is attached to the pane solely by adhesive bonding to the interior surface of the pane and is operably connected to the window frame.

In accordance with still another aspect of the present invention, a window assembly includes a pane having an interior surface, an exterior surface, a top peripheral edge, a bottom peripheral edge, and two side peripheral edges. A window opening frame includes a header with a hinge portion, a footer with a latching portion, and two sides. A hinge is attached to the pane solely by adhesive bonding to the interior surface of the pane proximate the top peripheral edge of the pane, and is hingedly attached to the hinge portion of the header. A latch assembly includes a latch bolt having one or more compound mounting pin slots. The latch bolt has a beveled latch portion, and the latch portion is operative to engage the latching portion of the footer. A latch bolt housing is attached to the pane solely by adhesive bonding to the interior surface of the pane proximate the bottom peripheral edge of the pane, and defines a cavity open in a direction substantially away from the top peripheral edge of the pane. There is at least one mounting pin within the cavity extending in a direction perpendicular to the plane of the pane into a corresponding mounting pin slot for compound sliding movement of the latch bolt between a latched position and an unlatched position. A spring is mounted to the latch bolt housing, and is operative to urge the latch bolt into the latched position. A release handle is mounted to the pane remote from the latch bolt, and is operative to move the latch bolt into the unlatched position against a force of the spring. The pane extends beyond the window frame to at least partially overlay each of the frame sides.

It is another objective of the present invention to overcome some or all of the deficiencies of the window assemblies described above. Additional aspects, features, and advantages of the window assemblies disclosed here will be apparent from the following detailed description of certain preferred embodiments.

### BRIEF DESCRIPTION OF THE DRAWINGS

FIG. 1 is an elevation view of a preferred embodiment of a window assembly in accordance with the present invention.

FIG. 2 is a section view, taken along line 2-2 of FIG. 1, of the window assembly of FIG. 1.

FIG. 3 is a section view, shown partially broken away, showing the frame of the window assembly of FIG. 1 installed adjacent a frame of another similar window assembly such that the panes of the window assemblies are in an abutting relationship.

FIG. 4 is a section view, taken along line 4-4 of FIG. 1, shown partially broken away, showing a hinge mechanism of the window assembly of FIG. 1.

FIG. 5 is a section view, taken along line 5-5 of FIG. 1, shown partially broken away, showing a latch assembly of the window assembly of FIG. 1.

FIG. 6 is an elevation view, shown partially broken away, of the latch assembly of FIG. 5.

FIG. 7 is an elevation view of an alternative embodiment of the latch bolt of the latch assembly of FIGS. 5 and 6.

FIG. 8 is a section view, shown partially broken away, of an alternative embodiment of the latch assembly of FIGS. 5 and 6.

FIG. 9 is a perspective view of the latch bolt of the latch assembly of FIGS. 5 and 6, shown in its latched position with respect to a shoulder of a vehicle.

FIG. 10 is a section view showing the latch bolt of the latch assembly of FIGS. 5 and 6 in its unlatched position with respect to a shoulder of a vehicle as the window is being opened.

FIG. 11 is a section view showing the latch assembly of FIGS. 5 and 6 in its unlatched position with respect to a shoulder of a vehicle as the window is being closed.

FIG. 12 is an elevation view of the latch assembly of FIGS. 5 and 6, shown in its unlatched position with respect to a shoulder of a vehicle, and with the window swung outwardly into an open position.

It should be understood that the appended drawings are not necessarily to scale, presenting a somewhat simplified representation of various preferred features illustrative of the basic principles of the invention. The specific design features of an egress window assembly as disclosed here, including, for example, specific dimensions of the hinge member and the latch mount, will be determined in part by the particular intended application and use environment. Certain features of the illustrated embodiments have been enlarged or distorted relative to others to facilitate visualization and clear understanding. In particular, thin features may be thickened, for example, for clarity of illustration. All references to direction and position, unless otherwise indicated, refer to the orientation of the egress window assemblies illustrated in the drawings.

### DETAILED DESCRIPTION OF CERTAIN PREFERRED EMBODIMENTS

It will be understood by those skilled in the art that the egress window assemblies disclosed and described herein are suitable for use in numerous applications, including recreational vehicles and mass transit vehicles. For purposes of illustration, various preferred and alternative features and aspects of the invention are now described in the context of a motor coach egress window.

The invention comprises a window assembly in which the window is capable of being opened to permit escape of the passengers in case of emergency, but that in normal operation is latched tightly to provide a watertight seal and to reduce wind noise. The window is flush mountable, that is, the window can be mounted such that the exterior surface of the window pane is flush with the exterior surface of the vehicle, and the window is capable of being mounted such that at least one peripheral edge is in an abutting relationship to a peripheral edge of an adjacent window pane. Additionally, the frame of the window is preferably a hidden frame, that is, it is not visible from the exterior of the vehicle save for that portion that might be visible through the window pane.

A preferred embodiment of a window assembly 2 in accordance with the present invention is seen in FIG. 1, and includes a frame 4 that fits around a window opening 6 that is defined by the body 5 of a vehicle. Frame 4 is secured to body 5 by adhesive, and a pane 7 is positioned within frame 4. A complete window assembly 2 can be mounted into window opening 6, or can alternatively be installed into window opening 6 in parts, i.e. an uncompleted assembly can be completed during installation. Frame 4 typically includes a header 8, a footer 10, a pair of sides or jambs 12, and optionally corner pieces 14. It will be understood that for window shapes that are not substantially square, rectangular, or rectilinear, frame 4 may lack components that are definable as a header, a footer, or jambs, and that window assemblies in accordance with the present invention for such alternate window shapes will have frames designed to fit the specific shape of the window opening.

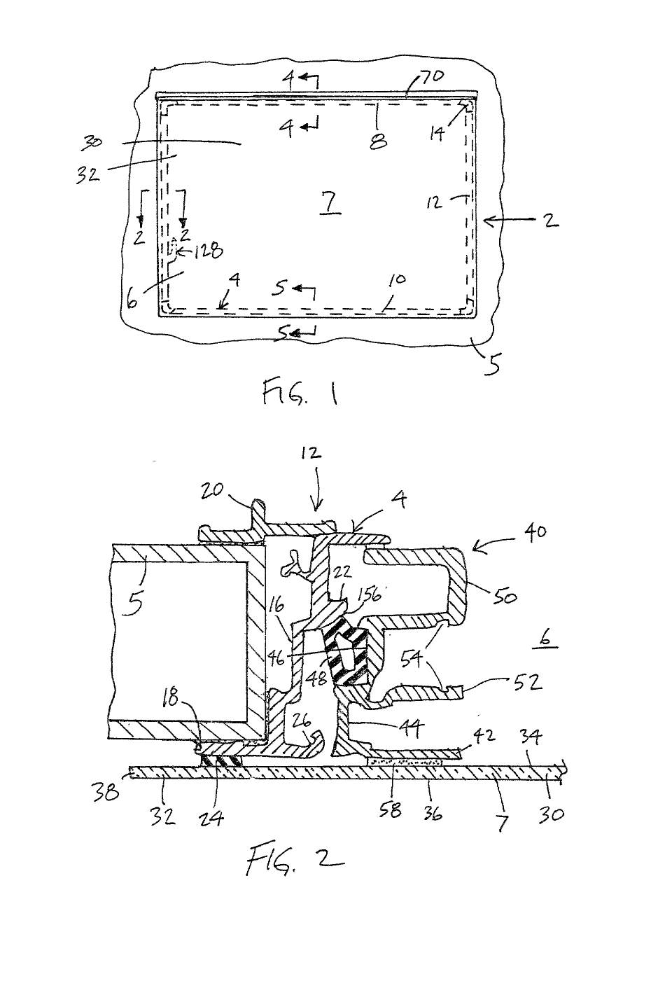

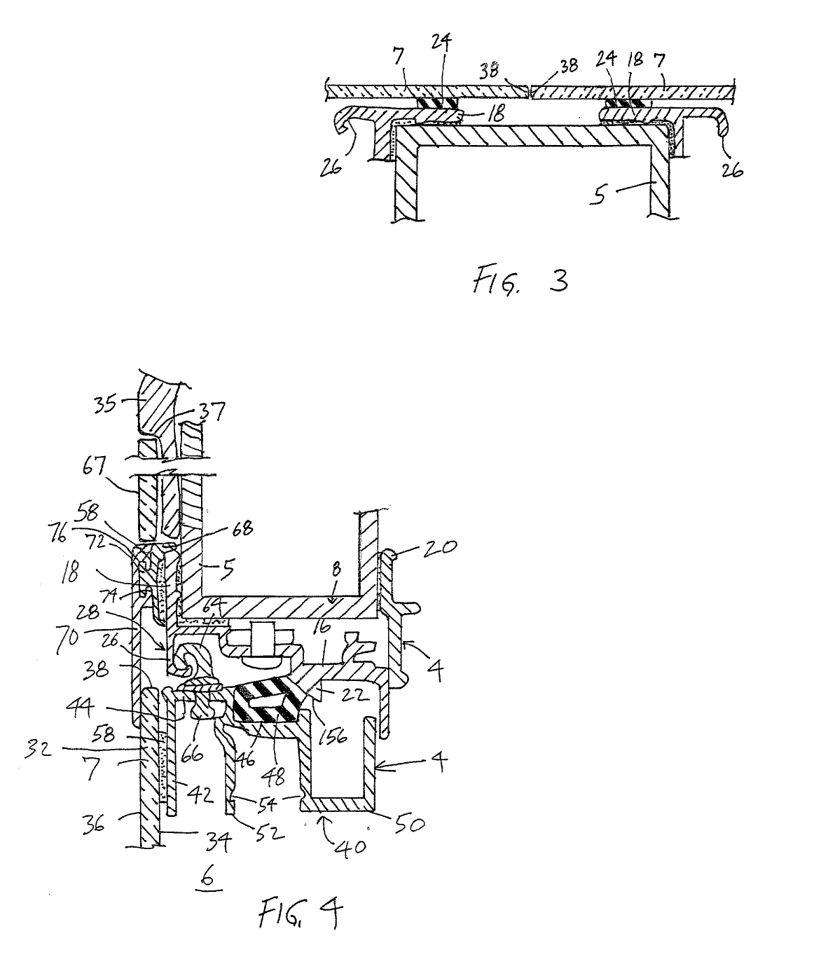

As seen in FIGS. 2, 4 and 5, frame 4 typically includes a cover piece 16 that covers the lip portion of window opening 6 and a flange 18 that extends away from window opening 6 along the exterior side of frame 4. Cover piece 16 in certain preferred embodiments includes a shoulder 22, further described below. A trim molding 20 may optionally extend away from window opening 6 on the interior side of frame 4. Trim molding 20 in certain preferred embodiments is unitary with frame 4, while in other preferred embodiments it comprises a separate piece or pieces and is optionally attached to frame 4 by an adhesive or other suitable fastening means. Trim molding 20 may comprise any suitable material, such as aluminum or plastic.

A bumper 24 is in certain preferred embodiments attached to the outer surface of at least a portion of flange 18. Alternately, bumper 24 could be adhesively attached to the inner peripheral portion of pane 7. Bumper 24 is typically comprised of a rubber or rubber blend, or a plastic or other suitable polymer, and serves to cushion the edge of pane 7 from vibration when the window is closed and to form a seal, reducing wind noise. Other suitable materials for bumper 24 will become readily apparent to those skilled in the art, given the benefit of this disclosure.

In certain preferred embodiments, cover piece 16 further includes a hook-shaped flange 26 extending into window opening 6 in a direction opposite that of flange 18. Hook-shaped flange 26 serves as a part of a hinge 28, described in greater detail below, and therefore need only be incorporated into the portions of frame 4 to which pane 7 is hingedly attached. Hook-shaped flange 26 may optionally extend along the full length of frame 4, in order to reduce the number of separate components by keeping all portions of frame 4 of the same design.

Frame 4 may be formed as a unitary structure, that is, a structure of one-piece construction, installable into window opening 6 from the exterior, with trim molding 20 added separately or formed as a unitary part of frame 4. Alternatively, frame 4 may be formed of two or more pieces that are joined at time of installation, either with or without trim molding 20 being unitary with the pieces that form frame 4.

In certain preferred embodiments, pane 7 may be formed of glass, tempered glass, laminated glass, or clear plastic. Pane 7 may, in certain preferred embodiments, be tinted. In other preferred embodiments, pane 7 may be formed of an opaque material. Pane 7 includes a central portion 30, which extends over the entirety of window opening 6, and a peripheral portion 32, which extends in at least one direction beyond window opening 6 to at least partially overlap body 5. Pane 7 has an interior surface 34, that is, a surface that faces the interior of the vehicle when the window is closed, an exterior surface 36 that faces the exterior of the vehicle when the window is closed, and a peripheral edge surface 38.

In certain preferred embodiments, a window frame 40 extends along at least part of the lower periphery of pane 7. Window frame 40 is preferably formed of either injection molded thermoplastic or a structural metal, more preferably aluminum. Other suitable materials for window frame 40 will become readily apparent to those skilled in the art, given the benefit of this disclosure. In certain preferred embodiments, window frame 40 extends completely along the peripheral portion of pane 7, and typically resides inwardly of peripheral edge surface 38 of pane 7, i.e., at least a portion of the peripheral portion 32 of pane 7 extends beyond the outermost edge of the window frame 40.

In certain preferred embodiments, window frame 40 includes a flange 42 extending substantially parallel to the plane of pane 7, suitable for adhesive attachment to pane 7. The term “the plane of pane 7,” when used herein, refers to a plane that corresponds substantially with pane 7 of the window assembly. Where pane 7 is curved or otherwise non-planar, the plane of pane 7 is that plane that corresponds substantially to the plane of that portion of pane 7 being referenced; e.g., the plane of pane 7 to which flange 42 is substantially parallel is the plane that corresponds substantially with the portion of pane 7 that is adjacent flange 42.

An extension 44 extending substantially perpendicularly to flange 42 towards the interior of the vehicle optionally contains a seal channel 46 for receiving an optional window frame seal 48, which is typically formed of rubber or plastic. Window frame 40 further includes a channel 50, with the walls of channel 50 being substantially parallel to the plane of pane 7 and channel 50 opening substantially away from the center of pane 7. Optionally, a second flange 52 extends from extension 44 in the same direction as flange 42. Second flange 52 may serve to support a second pane (not shown), which could be adhesively attached to second flange 52. Alternatively, a second pane could extend between second flange 52 and channel 50, being held in place by a gasket (not shown) that is retained by optional grooves 54 formed in second flange 52 and in the wall of channel 50.

Window frame 40 is preferably bonded to pane 7 at flange 42 by means of adhesive 58. This adhesive in certain preferred embodiments is formed of a primer layer applied to pane 7, a primer layer applied to window frame 40, and an adhesive, for example a urethane adhesive. Other suitable adhesives include moisture-activated urethanes, moisture-activated silicones, thermally-activated silicones, moisture-curable hot melt urethanes, thermally-activated modified epoxy, chemically-activated acrylate, and thermally-activated nitrile phenolic adhesives. Other suitable adhesives will become readily apparent to those skilled in the art, given the benefit of this disclosure. Window frame 40 is advantageously adhesively bonded only to interior surface 34 of pane 7 so that pane 7 may be flush with the exterior surface of an outer skin 35 of the vehicle, as seen in FIG. 5, where the lower peripheral edge 38 of pane 7 is seated against a shoulder 37 formed in outer skin 35. The term “adhesive bonding,” when used herein, includes embodiments where window frame 40 is extruded directly onto the interior surface of pane 7 and allowed to cure.

In the preferred embodiment shown in FIG. 4, window frame 40 is connected to frame 4 via hinge 28 so as to allow pane 7 to rotate outwardly of the vehicle to permit passengers to exit the vehicle, making window assembly 2 an egress window. A hook-shaped extension 64 is attached by rivets 66 to perpendicular extension 44 of window frame 40 such that the hook side faces the exterior of the vehicle. Hook-shaped extension 64 is hooked to the hook-shaped flange 26 of frame 4, typically at the header portion of frame 4. The hook-shaped extension 64 acts cooperatively with the hook-shaped flange 26 to support the window and permit it to be swung outwardly from a closed position over an are large enough to permit occupants of the vehicle to pass through the window opening. In certain preferred embodiments, the window can be swung outwardly further until hook-shaped extension 64 disengages from hook-shaped flange 26, thus permitting the window to be removed without the use of tools.

In certain preferred embodiments, as seen in FIG. 4, a second separate pane 67 is secured to vehicle 5 just above pane 7, such that its upper peripheral edge 38 of pane 7 is seated against shoulder 37 of outer skin 35. Consequently, the exterior surface 36 of pane 7 is substantially parallel to the exterior surface of pane 67 and the exterior surface of outer skin 35 of the vehicle. Since hinge 28 is secured to pane 7 via window frame 40, it is adhesively bonded only to the interior surface of pane 7, allowing the flush look of the window described above.

A weatherstrip retainer 68 is mounted to the vehicle body in certain preferred embodiments along the upper perimeter of window opening 6 to cover the small gap between pane 7 and pane 67. In certain preferred embodiments, weatherstrip retainer 68 is secured to flange 18 with adhesive 58. Weatherstrip retainer 68 is operable to retain a hinge weatherstrip 70. In certain preferred embodiments, weatherstrip retainer 68 has an extension 72 of substantially T-shaped cross-section extending outwardly from its outer face. In certain preferred embodiments, hinge weatherstrip 70 has a pair of hook-shaped extensions 74 that fit into grooves 76 created by T-shaped extension 72, thus permitting weatherstrip 70 to be slid on and off of weatherstrip retainer 68. The lower tip of weatherstrip 70, i.e. the end remote from the connection to weatherstrip retainer 68, overlaps peripheral edge surface 38 of pane 7 to prevent water from reaching the hinge area.

In certain preferred embodiments, as seen in FIGS. 5-12, a latch assembly 80 is slidingly mounted to pane 7 proximate peripheral edge surface 38 for movement between a first position and a second position in a plane substantially parallel to a plane defined by pane 7. A suitable latch assembly is described in commonly owned U.S. Application Ser. No. ______, entitled Egress Window Latching Mechanism, having Attorney Docket No. 11361-00016, and filed on Dec. 7, 2001, the entire disclosure of which is incorporated herein by reference for all purposes.

In certain preferred embodiments, latch assembly 80 includes a latch bolt housing 82. Latch assembly 80 is secured to, or formed as part of window frame 40, and, therefore, is bonded only to the interior surface 34 of pane 7. Latch assembly 80 accordingly travels with pane 7 when the window is opened and closed.

Latch bolt housing 82 is preferably formed of injection molded thermoplastic or a structural metal, e.g., aluminum. Other appropriate materials for latch bolt housing 82 will become readily apparent to those skilled in the art, given the benefit of this disclosure. Latch bolt housing 82 defines a cavity 84 having two side surfaces 86, a top surface 88, and, optionally, a back surface 90. Cavity 84 opens in a direction extending away from peripheral edge surface 38 of pane 7 and in a direction extending away from back surface 90.

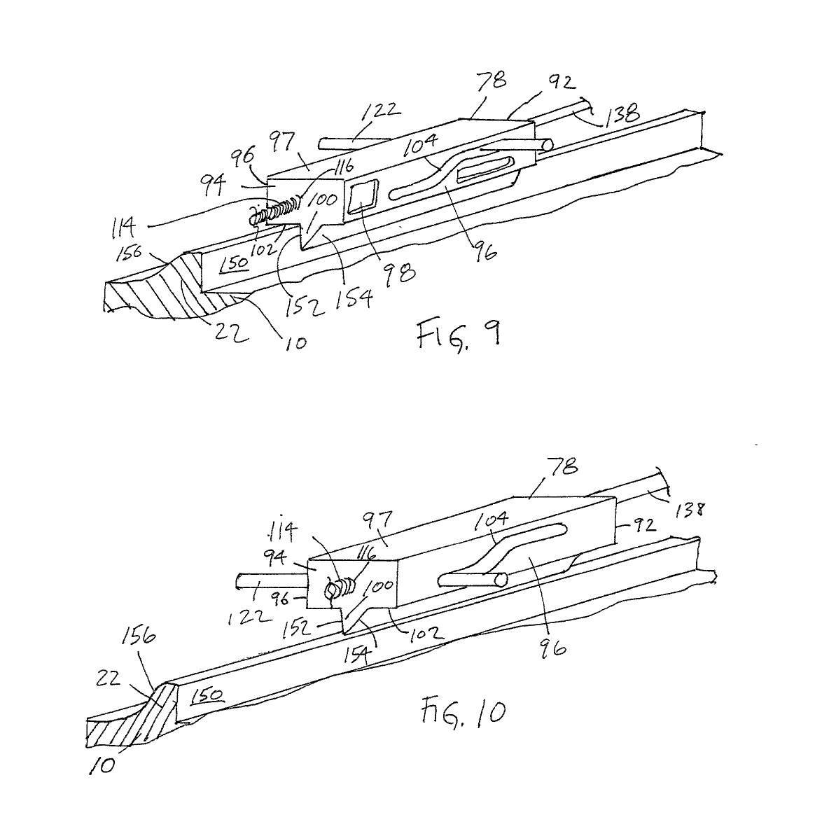

Latch assembly 80 includes a latch bolt 78 positioned in cavity 84. Latch bolt 78 has a front surface 92, a back surface 94, two side surfaces 96, a top surface 97, and a bottom surface 102. In certain preferred embodiments, side surfaces 96 of latch bolt 78, as well as side surfaces 86 of cavity 84, may contain recesses 98 (shown in FIG. 9 on side surface 96) so as to reduce the amount of surface area that will come in contact with other members, thereby reducing friction and the force required to operate the latch.

A biasing member such as a spring 114 is connected at a first end 116 to back surface 94 of latch bolt 78 and is connected at a second end 118 to back surface 90 of cavity 84. In embodiments where cavity 84 has no back surface, spring 114 can be connected at second end 118 to a spring pin, not shown, extending across cavity 84 in similar fashion as the mounting pins described below. Spring 114 serves to bias the latch bolt 78 to a first, typically closed, position, shown in FIG. 2. The biasing member may be, as noted above, a spring, e.g., a coil spring or leaf spring, or it may alternatively be elastic or resilient bands. Other suitable means for biasing the latch bolt to the first position will be readily apparent to those skilled in the art, given the benefits of this disclosure. Latch bolt 78 optionally has a beveled latch portion 100 extending downwardly from bottom surface 102.

One or more, preferably two, compound mounting pin slots 104 extend through latch bolt 78. The term compound mounting pin slot, when used herein, refers to a slot that has an angular, serpentine or curvilinear shape, and is not monolinear, that is, it does not have the form of a straight line. In certain preferred embodiments, compound mounting pin slots 104 are formed of a first segment 106 extending from a position proximate front surface 92 and top surface 97, toward back surface 94, substantially parallel to peripheral edge surface 38 of pane 7. A second segment 108 extends from a position proximate bottom surface 102 and back surface 94, toward front surface 92, laterally offset from first segment 106 and substantially parallel to peripheral edge surface 38 and first segment 106. A third segment 110 connects first segment 106 to second segment 108, and extends at an angle with respect to peripheral edge surface 38 and first and second segments 106, 108.

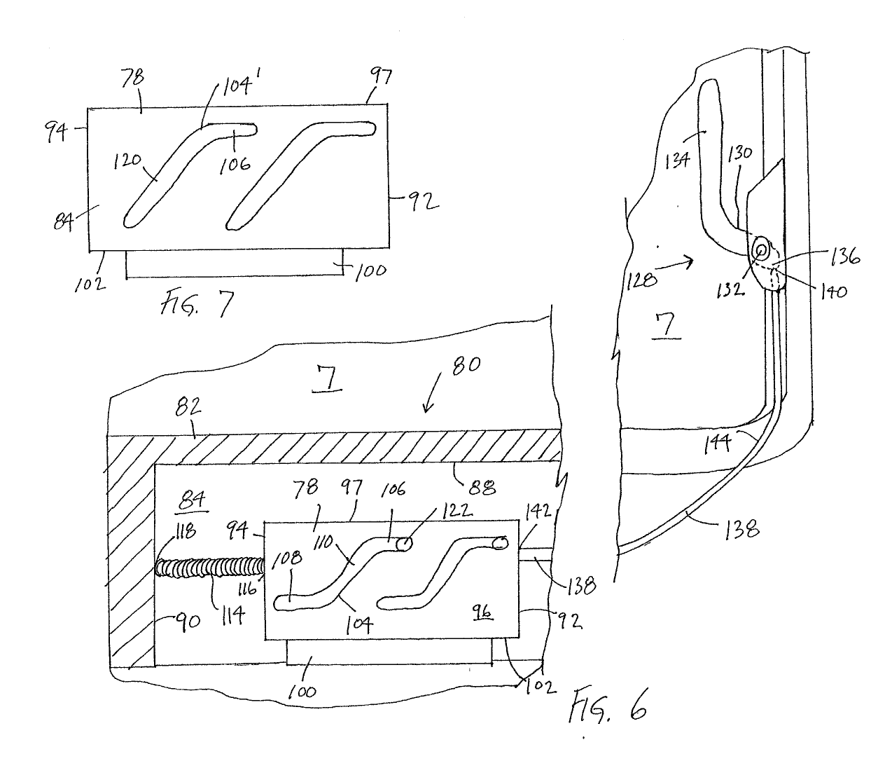

In other preferred embodiments, such as that illustrated in FIG. 7, where greater closing forces are required, compound mounting pin slots 104′ may be formed of a first segment 106 extending from a position proximate front surface 92 and top surface 97, toward back surface 94, substantially parallel to peripheral edge surface 38, and a second segment 120 extending from a position proximate bottom surface 102 and back surface 94 to first segment 106 at an angle with respect to peripheral edge surface 38 and first segment 106. Other configurations for the compound mounting pin slots including, for example, curvilinear slots or slots comprising multiple curvilinear segments; which would result in the latch bolt, upon being actuated as described below, moving in a forward and upward direction, will be readily apparent to those skilled in the art, given the benefit of this disclosure.

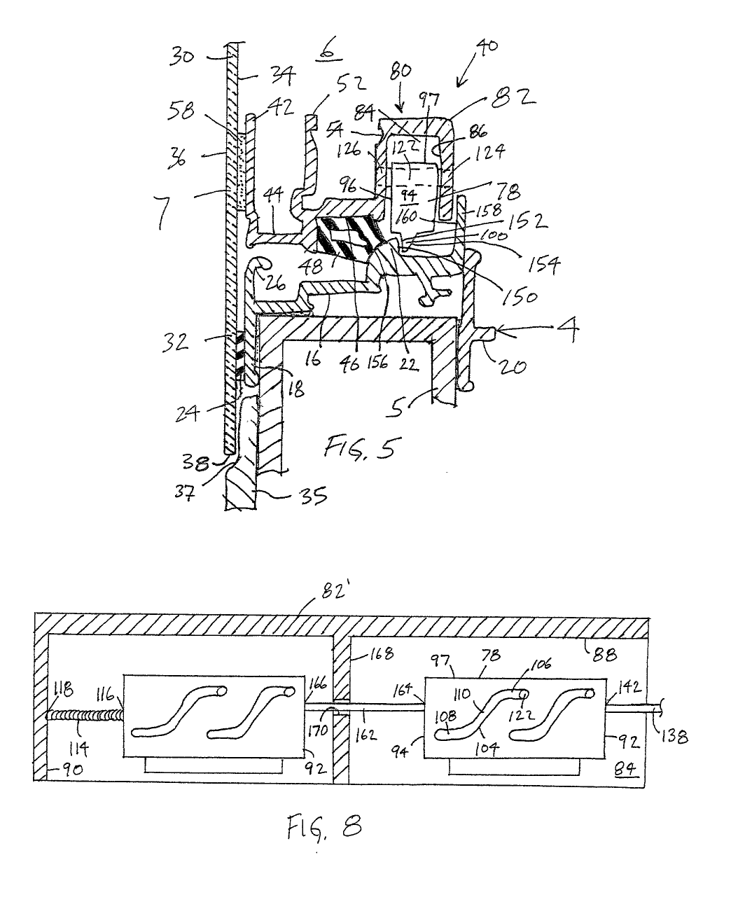

In certain preferred embodiments, as seen in FIGS. 5-6, one or more, preferably two, mounting pins 122 are attached at first ends 124 to a side surface 86 of cavity 84, and extend substantially perpendicular to the plane of the pane 7 into cavity 84. Each mounting pin 122 extends through a corresponding compound mounting pin slot 104 to slidingly mount latch bolt 78 to latch bolt housing 82. Mounting pins 122 typically comprise aluminum, steel, or other metal, and can be attached by any conventional method, e.g., welding. Alternatively, mounting pins 122 may be bolts extending through holes formed in the latch bolt housing and held in place by nuts. Other suitable materials for the mounting pins and attachment means will be readily apparent to those skilled in the art, given the benefit of the present disclosure.

In certain preferred embodiments, such as the one illustrated in FIG. 5, mounting pins 122 are attached at second ends 126 to the opposing side surface 86 of cavity 84. In other preferred embodiments, mounting pins 122 are attached only at a first end 124 to a side surface 86. In such an embodiment, a second end 126 of a mounting pin 122 extends only into a compound mounting pin slot 104, and does not extend completely through latch bolt 78. Consequently, in such an embodiment, compound mounting pin slots 104 need not extend entirely through latch bolt 78, but, rather, need to extend only far enough to accommodate the length of mounting pin 122. Further, in such an embodiment, mounting pin 122 may be attached to either side surface 86 of cavity 84.

As seen in FIGS. 2 and 6, a release mechanism 128 remote from latch bolt 78 is used to move latch bolt 78 from the first position toward the second position. In a preferred embodiment, release mechanism 128 includes a release handle 130. In certain preferred embodiments, release handle 130 is pivotally mounted at pivot pin 132 to pane 7 remote from latch bolt 78, that is, release handle 130 is not directly rigidly affixed to latch bolt 78. However, it is understood that release handle 130 is connected to latch bolt 78, either directly or indirectly, as described below with respect to a preferred embodiment.

In certain preferred embodiments, release handle 130 extends in an upward direction when the latch is in the closed position, as seen in FIGS. 2 and 6. A cam 136 is attached to handle 130 and pivots around pivot pin 132. An actuating cable 138 is attached at a first end 140 to cam 136 and at a second end 142 to front surface 92 of latch bolt 78. In certain preferred embodiments, actuating cable 138 runs along a directional channel 144 that translates the direction of actuating cable 138 from its attachment at cam 136 to the attachment at latch bolt 78 so that actuating cable 138 runs in a horizontal fashion from directional channel 144, substantially parallel to peripheral edge surface 38, to latch bolt 78.

Release handle 130 is capable of rotating to move latch bolt 78 into the second, typically unlatched, position. In certain preferred embodiments, release handle 130 rotates through a minimum of 45° to move latch bolt 78 from the first position to the second position, which is advantageous in that the average user associates such a degree of rotation with unlatching a window. Consequently, the use will be more aware that the window is unlatched and ready to be opened, particularly in an emergency situation. Further, in certain preferred embodiments, cam 136 functions to increase the leverage that release handle 130 applies to actuating cable 138 near the completion of the rotation of release handle 130, providing a noticeable lessening of force required to complete the rotation, and providing feedback via that lessening of force to the operator so that they might realize the window has become unlatched. Other suitable release handles, and other suitable means for moving the latch bolt from the first position toward the second position, will be readily apparent to those skilled in the art, given the benefit of this disclosure.

In certain preferred embodiments, as seen in FIGS. 5, 9-12, a shoulder 22 extends upwardly from footer 10. An engaging face 150 of shoulder 22 is engageable with an engaging face 152 of beveled latch portion 100 when latch bolt 78 is in the first position. Both engageable faces 150 and 152 optionally extend substantially vertical and parallel to the plane of pane 7. In other preferred embodiments, engaging face 150 may form an angle slightly less than 90° with respect to jamb 10, and engaging face 152 may form the same angle with respect to bottom surface 102 of latch bolt 78, such that a slight resistance exists to the moving of latch bolt 78 from the first position to the second position as described below (or such that a positive engagement is provided when latched). A second face 154 of beveled latch portion 100 and a second face 156 of shoulder 22 may be straight or optionally may be curvilinear, particularly an S-shaped curve. The two second faces 154, 156 are operable to slide over each other and permit “slam-shut” closure of the window in a self-latching fashion, that is, an open window may be slammed shut and will close, or latch, itself without further action being directed to the window or the latch assembly, as described below. Jamb 10 further includes a lip 158 having a face 160 that faces engaging face 150. When latch bolt 78 is in its latched position, face 160 engages latch bolt housing 82 such that lip 158 retains latch bolt 78 in an inboard-outboard direction. Other suitable configurations of shoulder 22 and beveled latch portion 100 will be readily apparent to those skilled in the art, given the benefit of this disclosure.

In certain preferred embodiments, the window assembly as described above can comprise multiple latch bolts. Each latch bolt in such an embodiment will essentially be a mirror image of the other and will be mounted in the same fashion described above. The multiple latches can be actuated by either a single or multiple release handles, and can be urged towards a first position by either a single biasing member or multiple biasing members. One such preferred embodiment is seen in FIG. 8,where two latch bolts 78 are shown. It is to be appreciated that three or more latch bolts are considered to be within the scope of the present invention. In addition to the structure described above with respect to the single latch bolt, this embodiment includes a connecting cable 162 attached at a first end 164 to back surface 94 of a first latch bolt 78, and attached at a second end 166 to front surface 92 of a second latch bolt 78. Latch housing 82′ may optionally comprise an intermediate span 168 extending downward from top surface 88 of cavity 84 and containing a channel 170 through which connecting cable 162 travels. A tie bar could optionally be used in place of connecting cable 162 to operatively connect latch bolts 78.

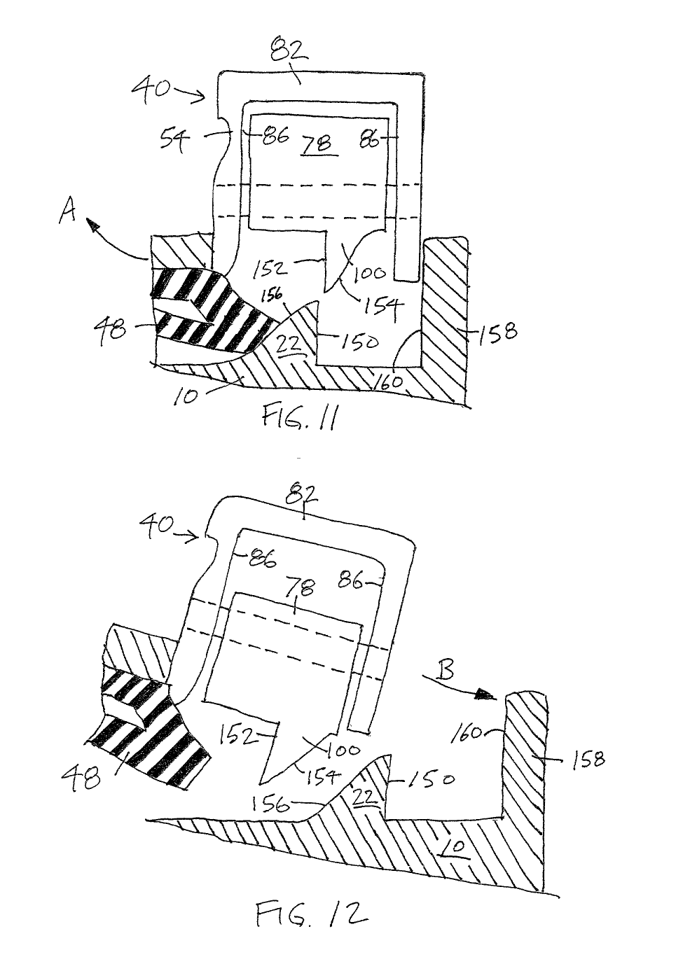

The mode of operation of certain preferred embodiments of the present invention will now be described. As can be seen in FIGS. 5, 6, 8, and 9, when the window is closed, latch bolt 78 is in the first or latched position, held there by the biasing of the spring 114. Engaging face 152 of latch bolt 78 is engaged with engaging face 150 of shoulder 22, and serves to prevent the window from being opened. To open the window, release handle 130 is turned or pivoted downward, and cam 136 serves to draw the first end of actuating cable 138 along with it as handle 130 is rotated. This motion of the first end of actuating cable 138 is translated via directional channel 144 to a horizontal movement of latch bolt 78 in a direction opposite the bias of spring 114. Upon experiencing this biasing force, latch bolt 78 moves in a horizontal direction with mounting pins 122 moving along first segment 106 until they encounter third segments 110. Latch bolt 78 then moves in an angular direction upward until mounting pins 122 encounter second segments 108. Latch bolt then moves horizontally as mounting pins move within second segments 108 to the second position, where mounting pins 122 encounter the ends of compound mounting pin slots 104. Accordingly, the movement of latch bolt 78 is a compound sliding movement, that is, an angular, serpentine or curvilinear movement, corresponding to mounting pins 122 moving along the compound mounting pin slots 104, and is not a monolinear or straight movement. This motion of latch bolt 78 draws beveled latch portion 100 away from spring 114 and upward with respect to jamb 10, such that beveled latch portion 100 and shoulder 22 are disengaged upon the completion of movement of latch bolt 78, as seen in FIGS. 10 and 11. This removes all obstacles to swinging pane 7 outwardly in the direction of arrow A, seen in FIG. 11, to open the window, permitting egress.

Upon the window being opened and release handle 130 being released to its original position, spring 114 biases latch bolt 78 back to the first position, as can be seen in FIG. 12. At this point, the window can be closed and latched from the exterior of the vehicle merely by slamming the window shut in the direction of arrow B. When second face 154 of beveled latch portion 100 encounters second face 156 of shoulder 22, the angle of the faces combines with the closing force being exerted to force latch bolt 78 upwardly in the direction dictated by compound mounting pin slots 104 against the bias of spring 114 until the lower edge of beveled latch portion 100 clears the upper edge of shoulder 22. As beveled latch portion 100 clears shoulder 22, latch bolt housing 82 engages lip 158, retaining latch bolt 78 in an inboard-outboard direction. When the window is thus in the fully closed position, spring 114 biases latch bolt 78 back into the first position, moving beveled latch portion 100 down such that it reengages shoulder 22 and latches the window shut.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A window assembly comprising:
a pane having an interior surface, an exterior surface, a top edge, a bottom edge, and two side edges;
a frame comprising a header, a footer with a latching portion, and two sides, the pane being positioned within the frame;
a window frame attached to the pane solely by adhesive bonding to the interior surface of the pane;
a hinge member attached to the pane solely by adhesive bonding to the interior surface of the pane proximate the top edge of the pane and operably connected to the header; and
a latch attached to the pane solely by adhesive bonding to the interior surface of the pane remote from the top edge of the pane and operable to engage the latching portion of the footer.

2. The window assembly of claim 1, wherein the pane extends beyond the window frame in at least one direction such as to at least partially overlay a side of the window frame.

3. The window assembly of claim 2, wherein the pane extends beyond the window frame a distance sufficient such that at least one side edge abuts a side edge of an adjacent window pane.

4. The window assembly of claim 1, wherein the latch assembly is self-latching.

5. The window assembly of claim 1, wherein the header includes a hinge portion to which the hinge member is operably connected.

6. The window assembly of claim 1, wherein the latch comprises:
a latch bolt housing mounted to the pane;
a latch bolt slidingly mounted to the latch bolt housing for movement in a plane substantially parallel to the plane of the pane between a first position and a second position;
a biasing member operative to urge the latch bolt toward the first position; and
a release handle remote from the latch bolt and operative to move the latch bolt from the first position toward the second position against a biasing force of the biasing member.

7. A window assembly comprising:
a pane;
a hinge; and
a latch assembly comprising:
a latch bolt housing mounted to the pane;
a latch bolt slidingly mounted to the latch bolt housing for movement in a plane substantially parallel to the plane of the pane between a first position and a second position;
a biasing member operative to urge the latch bolt toward the first position; and
a release handle remote from the latch bolt and operative to move the latch bolt from the first position toward the second position against a biasing force of the biasing member;
wherein the latch assembly and the hinge each is attached to the pane solely by adhesive bonding to an interior surface of the pane.

8. The window assembly of claim 7, further comprising a frame attached to the pane solely by adhesive bonding to the interior surface of the pane.

9. The window assembly of claim 7, wherein the frame extends along an entire perimeter of the pane.

10. The window assembly of claim 7, wherein the pane extends beyond the latch assembly and the frame.

11. The window assembly of claim 7, wherein the pane extends beyond the frame a distance sufficient to abut a pane of an adjacent window assembly.

12. A window assembly comprising:
a pane having an interior surface, an exterior surface, and a peripheral edge;
a window frame extending around a full perimeter of the pane inward of the peripheral edge of the pane and attached to the pane solely by adhesive bonding to the interior surface of the pane; and
a hinge member attached to the pane solely by adhesive bonding to the interior surface of the pane and operably connected to the window frame.

13. The window assembly of claim 12, further comprising a latch member having a first portion attached to the pane solely by adhesive bonding and a second portion mounted to the frame.

14. The window assembly of claim 12, wherein the pane extends beyond the window frame in at least one direction.

15. The window assembly of claim 12, wherein the window frame includes a hinge portion to which the hinge member is operably connected.

16. A window assembly comprising:
a pane having an interior surface, an exterior surface, a top peripheral edge, a bottom peripheral edge, and two side peripheral edges;
a window opening frame comprising a header with a hinge portion, a footer with a latching portion, and two sides;
a hinge attached to the pane solely by adhesive bonding to the interior surface of the pane proximate the top peripheral edge of the pane and hingedly attached to the hinge portion of the header;
a latch assembly comprising:
a latch bolt having one or more compound mounting pin slots, the latch bolt having a beveled latch portion wherein the latch portion is operative to engage the latching portion of the footer;
a latch bolt housing attached to the pane solely by adhesive bonding to the interior surface of the pane proximate the bottom peripheral edge of the pane and defining a cavity open in a direction substantially away from the top peripheral edge of the pane, comprising at least one mounting pin within the cavity extending in a direction perpendicular to the plane of the pane into a corresponding mounting pin slot for compound sliding movement of the latch bolt between a latched position and an unlatched position;
a spring mounted to the latch bolt housing, operative to urge the latch bolt into the latched position; and
a release handle mounted to the pane remote from the latch bolt, operative to move the latch bolt into the unlatched position against a force of the spring;
wherein the pane extends beyond the window frame to at least partially overlay each of the frame sides.

17. The window assembly of claim 16, wherein the pane extends beyond the window a distance sufficient such that at least one side edge of the pane abuts a side edge of an adjacent pane.

18. The window assembly of claim 16, wherein the latch assembly is self-latching.
